(19) United States
(12) Patent Application Publication
(10) Pub. No.: US 2002/0038800 A1
(43) Pub. Date: Apr. 4, 2002

(54) Formable thermoplastic laminate heating assembly useful in heating cheese and hot fudge

(76) Inventors: Keith Laken, Winona, MN (US); John W. Schlesselman, Fountain City, WI (US); Theodore Von Arx, La Crescent, MN (US); Jose Antonio Gutierrez, Kent, CT (US); Balakrishna Reddy, Ridgefield, CT (US); Robert Greene, Bridgewater, CT (US)

Correspondence Address: WILLIAM H. MURRAY, DUANE MORRIS & HECKSCHER LLP, ONE LIBERTY PLACE, PHILADELPHIA, PA, 19103-7396, US

(21) Appl. No.: 09/975,493

(22) Filed: Oct. 11, 2001

Related U.S. Application Data
(63) Continuation-in-part of application No. 09/782,350, filed on Feb. 12, 2001.
Application No. 09/782,350 is a continuation-in-part of application No. 09/642,215, filed on Aug. 18, 2000.

(51) Int. Cl. H05B 3/00

(52) U.S. Cl. 219/476; 219/535; 392/432

(57) ABSTRACT

A heating element assembly and a method of manufacturing heating assemblies. The heating assembly may be used for heating food products, including polypropylene bags containing cheese sauce or hot fudge, for example. The preferred heating assembly is configured to fit precisely around a standard cheese sauce bag, thus optimizing heat transfer between the heating assembly and the food product. The varied surface watt density of the heating assembly allows for accurate heat placement such that the food product can be efficiently and evenly warmed. A preferred embodiment of the heating element assembly includes two resistance heating elements. The first heating element is a temperature booster, while the second heating element is a maintenance heater to maintain heated food at a serving temperature.

### CROSS-REFERENCE TO RELATED APPLICATIONS

This is a continuation of U.S. application Ser. No. 09/782,350 which is a continuation in part of U.S. application Ser. No. 09/642,215 of Theodore Von Arx et al., filed Aug. 18, 2000, entitled “Formable Thermoplastic Laminate Heated Element Assembly.” This Application is related to U.S. application Ser. No. 09/369,779 of Theodore Von Arx, filed Aug. 6, 1999, entitled “Electrofusing of Thermoplastic Heating Elements and Elements Made Thereby”; U.S. application Ser. No. 09/416,731 of John Schlesselman and Ronald Papenfuss, filed Oct. 13, 1999, entitled “Heating Element Containing Sewn Resistance Material”; U.S. application Ser. No. 09/275,161 of Theodore Von Arx, James Rutherford and Charles Eckman, filed Mar. 24, 1999, entitled “Heating Element Suitable for Preconditioning Print Media” which is a continuation in part of U.S. application Ser. No. 08/767,156 filed on Dec. 16, 1996, now U.S. Pat. No. 5,930,459, issued on Jul. 27, 1999, which in turn is a continuation in part of U.S. application Ser. No. 365,920, filed Dec. 29, 1994, now U.S. Pat. No. 5,586,214, issued on Dec. 17, 1996; U.S. application Ser. No. 09/544,873 of Theodore Von Arx, Keith Laken, John Schlesselman, and Ronald Papenfuss, filed Apr. 7, 2000, entitled “Molded Assembly With Heating Element Captured Therein”; U.S. application Ser. No. 09/611,105 of Clifford D. Tweedy, Sarah J. Holthaus, Steven O. Gullerud, and Theodore Von Arx, filed Jul. 6, 2000, entitled “Polymeric Heating Elements Containing Laminated, Reinforced Structures and Processes for Manufacturing Same”; and U.S. application Ser. No. 09/309,429 of James M. Rutherford, filed May 11, 1999, entitled “Fibrous Supported Polymer Encapsulated Electrical Component,” which are all hereby incorporated by reference.

### FIELD OF THE INVENTION

This invention relates to electrical resistance heating elements, and more particularly to formable thermoplastic laminate heating element assemblies.

### BACKGROUND OF THE INVENTION

Methods for providing reformable heating element assemblies are described in Applicant's co-pending application Ser. No. 09/642,215, herein incorporated in its entirety by reference.

In the food service industry, equipment exists that will dispense heated cheese sauce from a bag. Such equipment is primarily used for “quick serve” vending for foods such as nachos. Typically, this dispensing equipment uses forced heated air to heat the cheese product, which is held in flexible polypropylene bags. One or more bags of cheese are placed on a tray that is mounted within the cabinet. Heated air flows over the bags and under the trays holding the bags. The heat source is typically a tubular metallic based heater positioned within the air flow forward of the main compartment where the cheese bags and trays are located.

Tubular heater wattage ranges from approximately 312 to 750 watts. Heating time for a standard cheese sauce bag (i.e., a bag size of 15 inches×11 inches×1.5 inches) is approximately 2 to 4 hours. FDA requirements associated with the prevention of Ecoli bacteria mandate that the cheese product be dispensed at a minimum temperature of 140 degrees Fahrenheit. Serving temperatures typically range from 140 to 180 degrees Fahrenheit.

The foregoing heating equipment is considered to be inefficient, unwieldy, and expensive to manufacture and operate. Thus, improved apparatus and methods for heating cheese sauce dispensing bags are desired.

### SUMMARY OF THE INVENTION

The present invention provides a heating assembly and a method of manufacturing heating assemblies. The heating assembly may be used for heating food products, including polypropylene bags containing cheese sauce. The preferred heating assembly is configured to fit nearly precisely around a standard cheese sauce bag, thus optimizing heat transfer between the heating assembly and the food product. The varied surface watt density of the heating assembly allows for better heat placement such that the food product can be efficiently and evenly warmed. A preferred embodiment of the heating tray includes two resistance heating elements. The first heating element is a temperature booster, while the second heating element is a maintenance heater to maintain heated food at a serving temperature.

A heating element assembly in accordance with a first embodiment of the invention includes a supporting substrate and a plurality of circuit paths, each circuit path comprising electrical resistance heating material attached to the supporting substrate, wherein at least one of the circuit paths has terminal end portions. At least one of the circuit paths continues onto a first flap portion of the resistance heating element assembly and is capable of rotation about a first axis of rotation. The resistance heating element is disposed between first and second thermoplastic sheets. The thermoplastic sheets and resistance heating element are joined together to form a reformable structure. The reformable structure is formed into a final element assembly configuration, such as by thermoforming, molding, bending, or drawing, etc., wherein at least the first flap portion is rotated about the first axis to provide resistance heating in at least two planes.

The present invention as described above provides several benefits. A plurality of intricate resistance circuit paths of one or more resistance heating materials may be secured to a planar supporting substrate and then joined between thermoplastic sheets, wherein the planar resistance heating element may then be reformed with the laminated structure to provide heat on a plurality of heat planes.

These heating structures provide intimate contact between the contents of the heating structures and the heat source, thereby providing inherent energy consumption advantages as well as the ability to intimately locate secondary devices such as thermistors, sensors, thermocouples, RTDs, etcetera, in proximity to the contents being heated or conditions being observed or recorded.

The heating element assembly also allows for an infinite number of circuit path shapes, allowing the circuit path to correspond to the general shape of a desired end product utilizing the heating element assembly. The heating element assembly may be folded to occupy a predefined space in an end product and to provide heat in more than one plane, thermoformed into a desired three dimensional heated plane, or stamped or die cut into a predetermined flat shape which may, then, be folded or thermoformed into a desired three dimensional heated shape. The heating element assembly thereby emulates well known sheet metal processing or known plastic forming processes and techniques.

The heating element assembly according to the present invention may also be over molded in a molding process whereby the resistance heating element is energized to soften the thermoplastic sheets and the heating element assembly is over molded with a thermoplastic to form a detailed molded structure. The energizing and overmolding steps may be timed such that the thermoplastic sheets and over molded thermoplastic form a substantially homogenous structure accurately capturing and positioning the resistance heating element within the structure. Alternatively, the heating element assembly may soften during mold flow without additional energizing.

In another embodiment of the present invention, a heating assembly is provided and includes integrally formed first and second generally parallel polymeric side walls. The polymeric side walls are connected to a narrow polymeric bottom portion. A resistance heating element is disposed within the first and second side walls. The resistance heating element includes a supporting substrate and at least two circuit paths. The circuit paths are defined by electrical resistance heating materials attached to, or disposed with the supporting substrate. The supporting substrate, which includes the circuit paths, is disposed within the first and second side walls.

In yet another embodiment of the present invention, a sheet of heating element assemblies comprises a first thermoplastic sheet, a second thermoplastic sheet affixed to the first thermoplastic sheet, and a sheet of resistance heating elements secured between and to the first and second thermoplastic sheets. The sheet of resistance heating elements includes a supporting substrate and a plurality of circuit paths attached to the substrate in spaced pairs, each circuit path comprising an electrical resistance heating material, at least one of the circuits of each pair of circuit paths having terminal end portions, at least one of each pair of circuit paths continuing onto a first flap portion of a resistance heating element capable of rotation about a first axis of rotation. The thermoplastic sheets are laminated together such that the sheet of resistance heating elements is secured between and to the first and second thermoplastic sheets to form a sheet of reformable heating element assemblies.

The sheet of heating element assemblies of this embodiment provides several benefits. The sheet may be inexpensively and efficiently produced using mass production techniques. The sheet may be collected into a roll, allowing the later separation and use of individual heating element assemblies or group of heated element assemblies as described above. The sheet, may be further or alternatively, processed using various secondary fabrication techniques, such as stamping, die cutting, or overmolding.

The above and other features of the present invention will be better understood from the following detailed description of the preferred embodiments of the invention which is provided in connection with the accompanying drawings.

### A BRIEF DESCRIPTION OF THE DRAWINGS

The accompanying drawings illustrate preferred embodiments of the invention, as well as other information pertinent to the disclosure, in which:

FIG. 1 is a top plan view of a pair of resistance wires disposed in predetermined circuit paths according to an exemplary embodiment of the invention;

FIG. 2 is a front perspective view of a preferred programmable sewing machine and computer for manufacturing resistance heating elements;

FIG. 3 is an isometric view of an embodiment of the heating assembly according to the invention, with a portion of a laminate surface removed to reveal a portion of the resistance heating element;

FIG. 4 is a partial cross-sectional elevation view of the heating element assembly shown in FIG. 3, taken along line 4-4;

FIG. 5 is a partial cross-sectional view of a multi-layered heating element assembly according to the invention;

FIG. 6 is a diagram of an exemplary method of manufacturing a sheet of heated element assemblies according to the invention;

FIG. 7 is a diagram of a sheet of resistance heating elements shown in partial view according to the invention;

FIG. 8 is a top plan view of a resistance heating element assembly wherein the laminated structure has been cut to form a profile for a heating assembly, which may be folded to form a three dimensional heating assembly;

FIG. 9 is a top plan view of a heating element assembly including the resistance heating element of FIG. 8 wherein a portion the top laminated surface has been removed to show the resistance heating element, before being formed into a final configuration;

FIG. 10 is an isometric view of a heating assembly formed from the cut resistance heating element assembly of FIG. 9; and

FIG. 11 is a performance graph of an exemplary heating assembly used to heat a standardized bag of cheese sauce.

### DETAILED DESCRIPTION OF PREFERRED EMBODIMENTS

The present invention provides a thermoplastic laminate heating element assembly including resistance heating elements, in the form of a heating tray. As used herein, the following terms are defined:

“Laminate” means to unite, for example, layers of laminate via bonding them together, usually with heat, pressure and/or adhesive. It normally is used to refer to flat sheets, but also can include rods and tubes. The term refers to a product made by such bonding;

“Serpentine Path” means a path which has one or more curves for increasing the amount of electrical resistance material in a given volume of polymeric matrix, for example, for controlling the thermal expansion of the element;

“Melting Temperature” means the point at which a fusible substance begins to melt;

“Melting Temperature Range” means the temperature range over which a fusible substance starts to melt and then becomes a liquid or semi-liquid;

“Degradation Temperature” means the temperature at which a thermoplastic begins to permanently lose its mechanical or physical properties because of thermal damage to the polymer's molecular chains;

“Evacuating” means reducing air or trapped air bubbles by, for example, vacuum or pressurized inert gas, such as argon, or by bubbling the gas through a liquid polymer. “Fusion Bond” means the bond between two fusible members integrally joined, whereby the polymer molecules of one member mix with the molecules of the other. A Fusion Bond can occur, even in the absence of any direct or chemical bond between individual polymer chains contained within said members;

“Fused” means the physical flowing of a material, such as ceramic, glass, metal or polymer, hot or cold, caused by heat, pressure or both;

“Electrofused” means to cause a portion of a fusible material to flow and fuse by resistance heating;

“Stress Relief” means reducing internal stresses in a fusible material by raising the temperature of the material or material portion above its stress relief temperature, but preferably below its Heat Deflection Temperature;

“Flap” or “Flap Portion” means a portion of an element which can be folded without damaging the element structure; and

### Resistance Heating Element

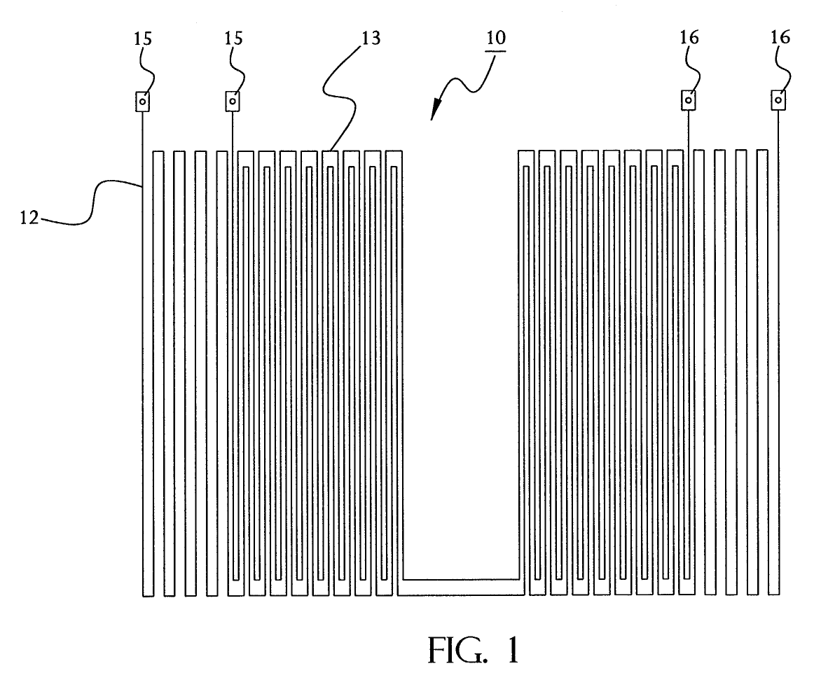

With reference to FIGS. 1-8, there is shown an embodiment of a resistance heating element 10, preferably having about 50-95% of the surface area of a heating assembly. The preferred resistance heating element 10 may include a regulating device for controlling electric current. Such a device can include, for example, a thermistor, a thermocouple, or a RTD, for preventing overheating of the polymeric materials disclosed in this invention, or a self-regulating material. The resistance heating elements 10 of this invention can take on any number of shapes and sizes, including squares, ovals, irregular circumference shapes, tubes, cup shapes and container shapes. Sizes can range from less than one inch square to 21 in.×26 in., and greater sizes can be available if multiple elements are joined together. Greater sizes are also available with roll, or continuous element forms.

As shown in FIG. 1, the resistance heating element 10 includes one or more resistance wires 12 and 13 disposed in predetermined circuit paths. The ends of each resistance wire 12 and 13 are coupled to a pair of electrical connectors 15 and 16 using known techniques such as, riveting, grommeting, brazing, clinching, compression fitting or welding. The circuit includes a resistance heating material, which may be a resistance heating wire 12 or 13 wound into a serpentine path containing, for example, about 1-200 windings, or, a resistance heating material, such as ribbon, a foil, a printed circuit, or ink. Preferably, the resistance heating wires 12 and 13 include a Ni—Cr alloy, although certain copper, steel, and stainless-steel alloys could be suitable. A positive temperature coefficient wire or conductive polymer may also be suitable. The resistance heating wires 12 and 13 can be provided in separate parallel paths, or in separate layers. Whatever material is selected, it should be electrically conductive, and heat resistant. It should also be resilient to subsequent forming operation, either on its own, as in the base of a wire or scrim, or encapsulated within a polymer. A tensile strength of at least about 10,000 psi, and preferably at least about 50,000 psi for the fiber or resulting composite is helpful. (See ASTM D3379, D3039).

Alternatively, continuous or closed loop heating wires may be provided, in which case current is induced into the heating element by means such as high frequency radiation or magnetic induction.

### Substrates

As used herein, the term “supporting substrate” refers to the base material on which the resistance material, such as wires, are applied, or impregnated within, as is the case with a graphite powder for example. The supporting substrate 11 of this invention should be capable of being pierced, penetrated, or surrounded, by a sewing needle for permitting the sewing operation. Other than this mechanical limitation, the substrates of this invention can take on many shapes and sizes. Flat flexible substrates are preferably used for attaching an electrical resistance wire with a thread. Non-plastic materials, such as glasses, semiconductive materials, and metals, can be employed so long as they have a pierceable cross-sectional thickness, e.g., less than 0.010 inch−0.020 inch, or a high degree of porosity or openings therethrough, such as a grid, scrim, woven or non-woven fabric, for permitting the sewing needle of this invention to form an adequate stitch. The supporting substrate 11 of this invention need not necessarily contribute to the mechanical properties of the final heating element, but may contain high strength fibers.

Alternatively, the supporting substrate 11 of this invention may contain ordinary, natural, or synthetic fibers, such as cotton, glass, wool, silk, rayon, nylon, polyester, polypropylene, polyethylene, or mixtures thereof, etc. The supporting substrate may also comprise a synthetic fiber, such as Kevlar fibers, that has good thermal uniformity and strength. The advantage of using ordinary textile fibers, is that they are available in many thicknesses and textures and can provide an infinite variety of chemistry, porosity and melt-bonding ability. The fibers of this invention, whether they be plastic, natural, ceramic or metal, can be woven, or spun-bonded to produce non-woven textile fabrics.

Specific examples of supporting substrates 11 useful in this invention include polymer, ceramic, glass or metallic films, such as non-woven fiberglass mats bonded with an adhesive or sizing material such as model 8440 glass mat available from Johns Manville, Inc. Additional substrates can include polymer impregnated fabric organic fabric weaves, such as those containing nylon, rayon, or hemp etc., porous mica-filled plate or sheet, and thermoplastic sheet film material. In one embodiment, the supporting substrate 11 contains a polymeric resin which is also used in either the first thermoplastic sheet 110 or second thermoplastic sheet 105, or both of a heated element assembly 100 described below. Such a resin can be provided in woven or non-woven fibrous form, or in thin sheet material having a thickness of 0.020 inch or less. Thermoplastic materials can be used for the supporting substrate 11 which will melt-bond or liquefy with the thermoplastic sheets 110, 105, so as to blend into a substantially uniform structure.

### Sewing Operation

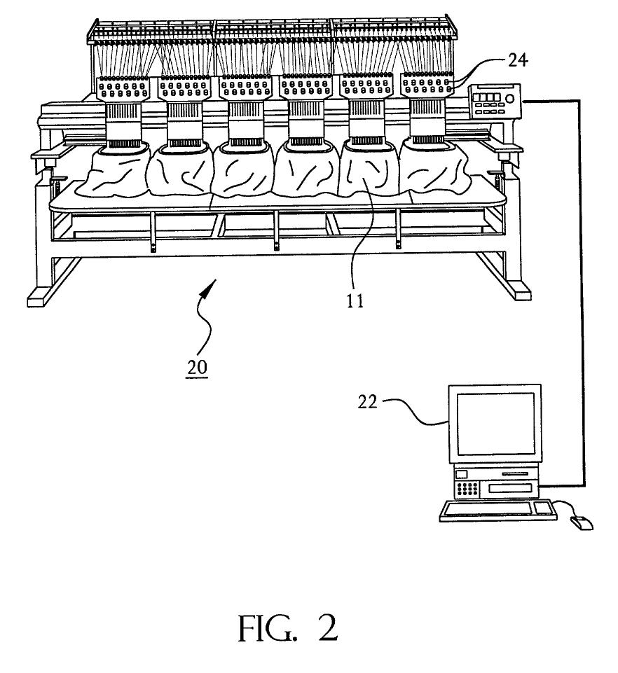

With reference to FIG. 2, the preferred programmable sewing machine 20 will now be described. The preferred programmable sewing machine is one of a number of powerful embroidery design systems that use advanced technology to guide an element designer through design creation, set-up and manufacturing. The preferred programmable sewing machine 20 is linked with a computer 22, such as a personal computer or server, adapted to activate the sewing operations. The computer 22 preferably contains or has access to, embroidery or CAD software for creating thread paths, borders, stitch effects, etc.

The programmable sewing machine 20 includes a series of bobbins 24 for loading thread and resistance heating wire or fine resistance heating ribbon. Preferably, the bobbins 24 are pre-wound to control tension since tension, without excessive slack, in both the top and bottom bobbins 24 is very important to the successful capturing of resistance heating wire on a substrate. The thread used should be of a size recommended for the preferred programmable sewing machine. It must have consistent thickness since thread breakage is a common mode of failure in using programmable sewing machines. An industrial quality nylon, polyester or rayon thread is highly desirable. Also, a high heat resistant thread may be used, such as a Kevlar thread or Nomex thread known to be stable up to 500° F. and available from Saunders Thread Co. of Gastonia, N.C.

The programmable sewing machine preferably has 1-20 heads and can measure 6 foot in width by 19 feet long. The sewing range of each head is about 10.6 inches by 26 inches, and with every other head shut off, the sewing range is about 21 inches by 26 inches. An acceptable programmable sewing machine is the Tajima Model No. TMLG116-627W (LT Version) from Tajima, Inc., Japan.

The preferred method of capturing a resistance heating wire 12, 13 onto a supporting substrate 11 in this invention will now be described. First, an operator selects a proper resistive element material, for example, Ni—Cr wire, in its proper form. Next, a proper supporting substrate 11, such as 8440 glass mat, is provided in a form suitable for sewing. The design for the element is preprogrammed into the computer 22 prior to initiating operation of the programmable sewing machine 20. As with any ordinary sewing machine, the programmable sewing machine 20 of this invention contains at least two threads, one thread is directed through the top surface of the supporting substrate, and the other is directed from below. The two threads are intertwined or knotted, ideally somewhere in the thickness of the supporting substrate 11, so that one cannot view the knot when looking at the stitch and the resulting resistance heating element 10. As a top needle penetrates the substrate 11 and picks up a loop of thread mechanically with the aid of the mechanical device underneath, it then pulls it upward toward the center of the substrate 11 and if the substrate is consistent and the thread tension is consistent, the knots will be relatively hidden. In a preferred embodiment of this invention, the resistance heating wire 12, 13 is provided from a bobbin in tension. The preferred programmable sewing machine 20 of this invention provides a third thread bobbin for the electrical resistance wire 12, 13 so that the programmable sewing machine 20 can lay the resistance wire 12, 13 down just in front of the top needle. The preferred operation of this invention provides a zig zag or cross stitch pattern, whereby the top needle criss-crosses back and forth as the supporting substrate 11 is moved, similar to the way an ornamental rope is joined to a fabric in an embroidery operation. A simple looping stitch with a thread 14 is also shown. By guiding the top needle over either side of the resistance heating wire 12, 13 the heating wire 12, 13 is captured in a very effective manner, the process being computer controlled so that the pattern can be electronically downloaded into the computer 22 and automatically sewn onto a substrate of choice.

The programmable sewing machine 20 can sew an electrical resistance heating wire 12, 13 having a diameter or thickness of 0.005 inch-0.25 inch, onto a supporting substrate 11 at a rate of about 10-500 stitches per minute, saving valuable time and associated cost in making resistance heating elements.

The ability to mechanically attach resistive elements, such as wires, films and ribbons, to substrates provides a multitude of design possibilities in both shape and material selection. Designers may mix and match substrate materials by selecting their porosity, thickness, density and contoured shape with selected resistance heating materials ranging in cross-section from very small diameters of about 0.005 inch to rectangular and irregular shapes, to thin films. Also, secondary devices such as circuits, including microprocessors, fiberoptic fibers or optoelectronic devices, (LEDs, lasers) microwave devices (power amplifiers, radar) and antenna, high temperature sensors, power supply devices (power transmission, motor controls) and memory chips, could be added for controlling temperature, visual inspection of environments, communications, and recording temperature cycles, for example. The overall thickness of the resistance heating element is merely limited by the vertical maximum position of the needle end, less the wire feed, which is presently about 0.5 inch, but may be designed in the future to be as great as 1 inch or more. Resistive element width is not nearly so limited, since the transverse motion of the needle can range up to one foot or more.

The use of known embroidery machinery in the fabrication of resistance heating elements allows for a wide variety of raw materials and substrates to be combined with various resistance heating materials. The above construction techniques and sewing operation also provide the ability to manufacture multi-layered substrates, including embedded metallic and thermally conductive layers with resistance wires wrapped in an electrically insulating coating, so as to avoid shorting of electric current. This permits the application of a resistance heating wire to both sides of the thermally conductive metallic layer, such as aluminum foil, for more homogeneously distributing resistance heat.

### Thermoplastic Laminate Heating Element Assembly Construction

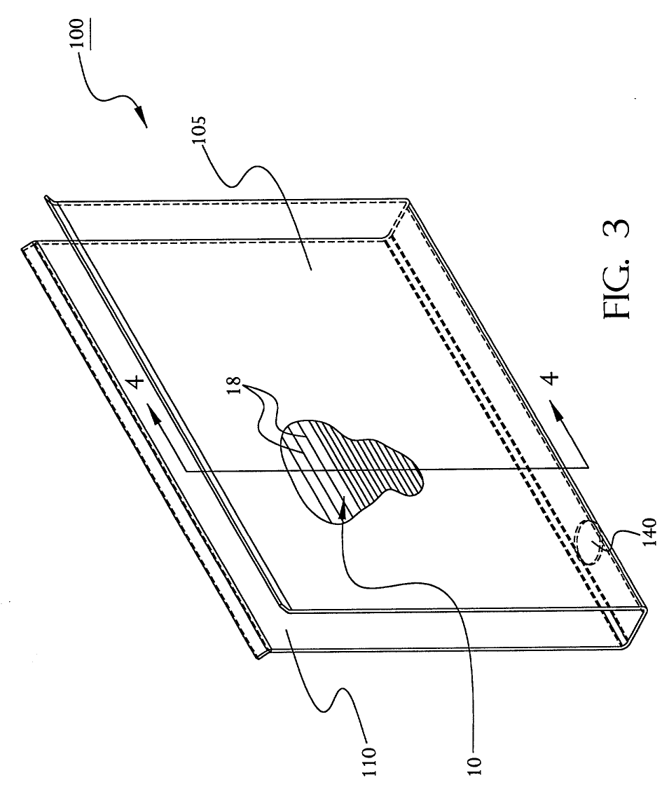

FIG. 3 shows an exemplary heating element assembly 100, according to the invention. The heating element assembly 100 includes a resistance heating element 10 disposed between laminated first and second thermoplastic sheets 105, 110. For illustrative purposes, the first thermoplastic sheet 105 is shown partially removed from the second thermoplastic sheet 110. The resistance heating element 10, described above, at least substantially encompasses the circuit paths, defined by resistance wires 12 and 13. A through-hole 140 is provided in the base of the heating assembly, which is shaped to receive a nozzle for dispensing the contents of the heating assembly.

The supporting substrate of the resistance heating element 10 has a thickness between than 0.005 inch and 0.25 inch, and is preferably 0.25 inch thick. The supporting substrate should be flexible, either under ambient conditions or under heat or mechanical stress, or both. A thin semi-rigid heating element assembly 100 allows for closer proximity of the resistance heating wires 12 and 13 to an object to be heated when the heating element assembly is formed into a final element assembly, such as an assembly for heating cheese, hot fudge, etc. Because less heat needs to be generated by the resistance heating element 10 to provide heat to the outer surfaces of a thin heating element assembly 100, materials having lower RTI (Relative Thermal Index) ratings can be successfully used in thin heating element assemblies.

The thermoplastic sheets 105, 110 are laminated to each other to secure resistance heating element 10 and to form a reformable continuous element structure. The thermoplastic sheets 105, 110 may be heated and compressed under sufficient pressure to effectively fuse the thermoplastic sheets together. A portion of this heat may come from energizing the resistance heating element 10. Alternatively, thermosetting polymer layers could be employed, such as B-stage epoxy sheet or pre-preg material..

Preferred thermoplastic materials include, for example: fluorocarbons, polypropylene, polycarbonate, polyetherimide, polyether sulfone, polyaryl-sulfones, polyimides, and polyetherkeytones, polyphenylene sulfides, polyether sulfones, and mixtures and co-polymers of these thermoplastics. An acceptable thermoplastic polyetherimide is available from the General Electric Company under the trademark ULTEM.

It is further understood that, although thermoplastic materials are preferable for forming fusible layers because they are generally heat-flowable, some thermoplastics, notably polytetraflouroethylene (PTFE) and ultra high-molecular-weight polyethylene (UHMWPE) do not flow under heat alone. Also, many thermoplastics are capable of flowing without heat, under mechanical pressure only.

Acceptable results were achieved when forming a heating element assembly under the conditions indicated in TABLE 1 as follows:

TABLE

| | THICKNESS | | | |
|---|---|---|---|---|
| | OF SHEET | PRESSURE | TIME | TEMP. |
| MATERIAL | (inch) | (PSI) | (minutes) | (° F.) |
| Polypropylene | 0.009 | 22 | 10 | 350 |
| Polycarbonate | 0.009 | 22 | 10 | 380 |
| Polysulfone | 0.019 | 22 | 15 | 420 |
| Polyetherimide | 0.009 | 44 | 10 | 430 |
| Polyethersulfone | 0.009 | 44 | 10 | 460 |

Where no vacuum was applied, “thickness” is the thickness of the thermoplastic sheets in inches, “pressure” represents the amount of pressure (in psi) applied to the assembly during lamination, “temperature” is the temperature applied during lamination, and “time” is the length of time that the pressure and heat were applied. It will be understood the above-identified material thicknesses used in forming exemplary embodiments of the assembly described herein are merely provided by way of example. Materials of differing thicknesses may also be used to achieve acceptable results without departing from the scope of the invention.

The first and second thermoplastic sheets 105, 110 and resistance heating element 10 of the heating element assembly 100 may also be laminated to each other using an adhesive. In one embodiment of the present invention, an adhesive to hold the materials together, which may be an ultraviolet curable adhesive, may be disposed between the resistance heating element 10 and the first thermoplastic sheet 105 and between the resistance heating element 10 and the second thermoplastic sheet 110, as well as between areas of the thermoplastic sheets 105, 110 which are aligned to be in direct contact. An ultraviolet curable adhesive may be used that is activated by ultraviolet light and then begins to gradually cure. In this embodiment of the present invention, the adhesive may be activated by exposing it to ultraviolet light before providing the second of the thermoplastic sheets 105, 110. The thermoplastic sheets 105, 110 may then be compressed to substantially remove any air from between the sheets 105, 110 and to secure resistance heating element 10 therebetween.

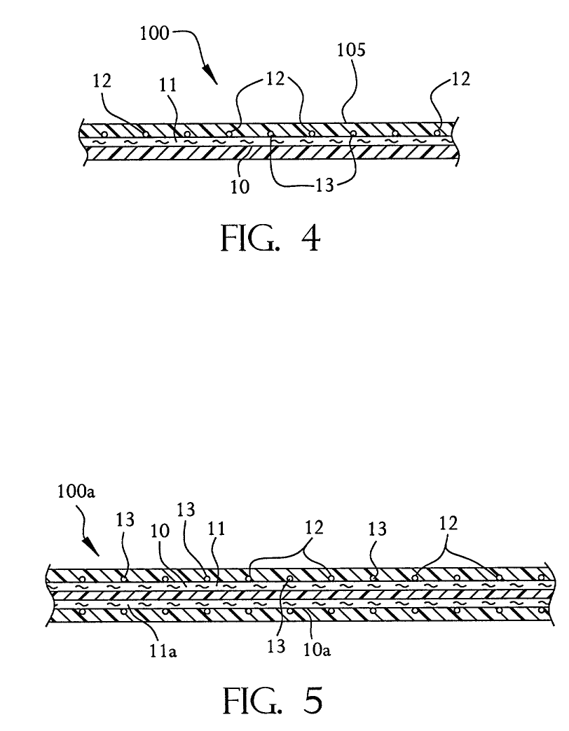

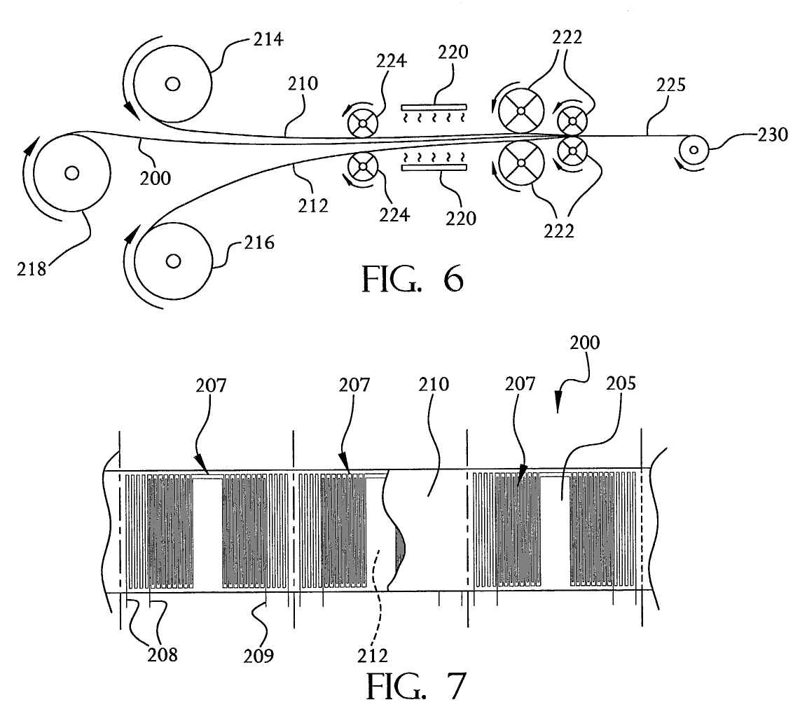

FIG. 5 illustrates that a heating element assembly 100a may include a plurality of heated layers. A second resistance heating element 10a may be laminated between one of thermoplastic sheets 105, 110 and a third thermoplastic sheet 115.

The thicknesses of thermoplastic sheets 105, 110 and the thickness of supporting substrate 11 and resistance heating wires 12 and 13 are preferably selected to form a reformable continuous element structure that maintains its integrity when the element is formed into a final element structure. The preferred heating element assembly 100 according to the invention, then, is a semi-rigid structure in that it may be reformed, such as by simply molding, folding or unfolding under heat, pressure, or a combination thereof as required by the chosen thermoplastics, into a desired shape without sacrificing structural integrity.

Heating assemblies 100 according to the present invention provide several advantages over non-rigid and rigid trays which do not include an integrated heat source. The heat source, i.e., the resistance heating element 10, intimately surrounds the contents of a heating assembly 100, which may be, for example, a food product, or other contents, whether they be solid, semi-solid or liquid. Also, secondary devices as described above, such as temperature sensors, gauges, thermocouples, RTD's may be disposed more intimately with the contents or conditions that are being monitored.

A heating assembly 100 may also be positioned in a mold over molded, or both, to form a selected molded heated structure. Some plastics may be energized prior to and or during over molding for improved bonding with the over molded material. A heating assembly 100 may optionally be thermoformed to conform to at least a part of the mold structure and to preferentially align the resistance heating element within the mold. Once the heating assembly is positioned within a mold, the resistance heating element 10 of the heating assembly 100 may be energized to soften the thermoplastic sheets, and the heating assembly may be over molded with a thermoplastic. The energizing and overmolding may be timed such that the thermoplastic sheets and over molded thermoplastic form a substantially homogenous structure when solidified. Alternatively, the thermoplastic sheets may be allowed to soften as a result of mold flow alone. The thermoplastic materials of the sheets and over molded thermoplastic are preferably matched to further facilitate the creation of a homogenous structure. The supporting substrate 11 may also be selected to be a thermoplastic to better promote the formation of a homogenous structure. The energizing may be timed to soften the thermoplastic sheets before, after, or during the overmolding process, depending upon the standard molding parameters, such as the flow characteristic of the selected thermoplastics, the injection molding fill time, the fill velocity, and mold cycle. The assembly is also amenable to other molding processes, such as injection molding, compression molding, thermoforming, and injection-compression molding.

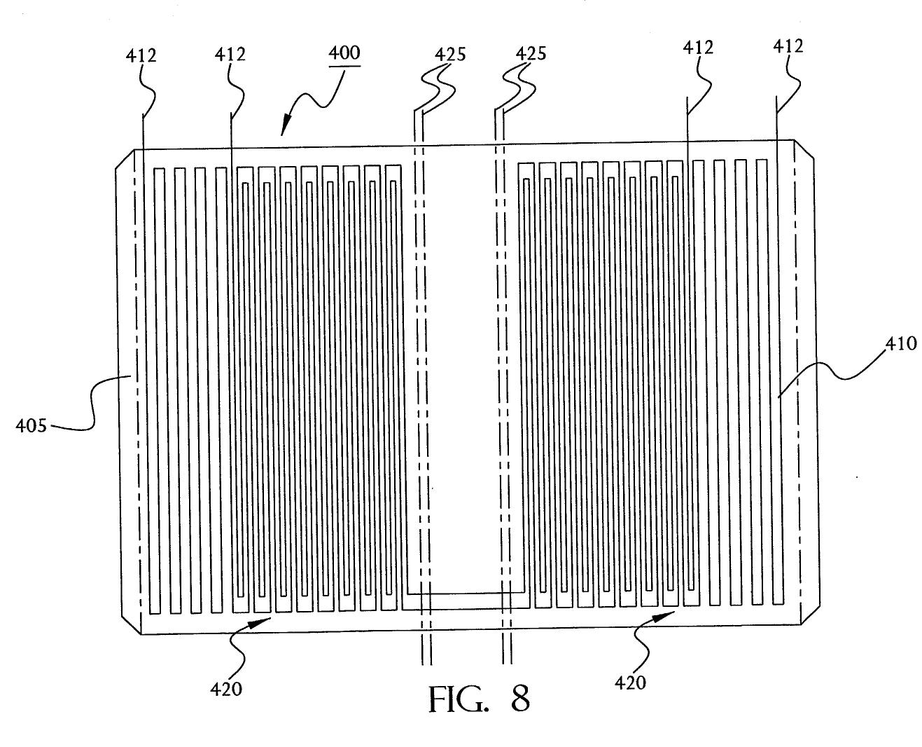

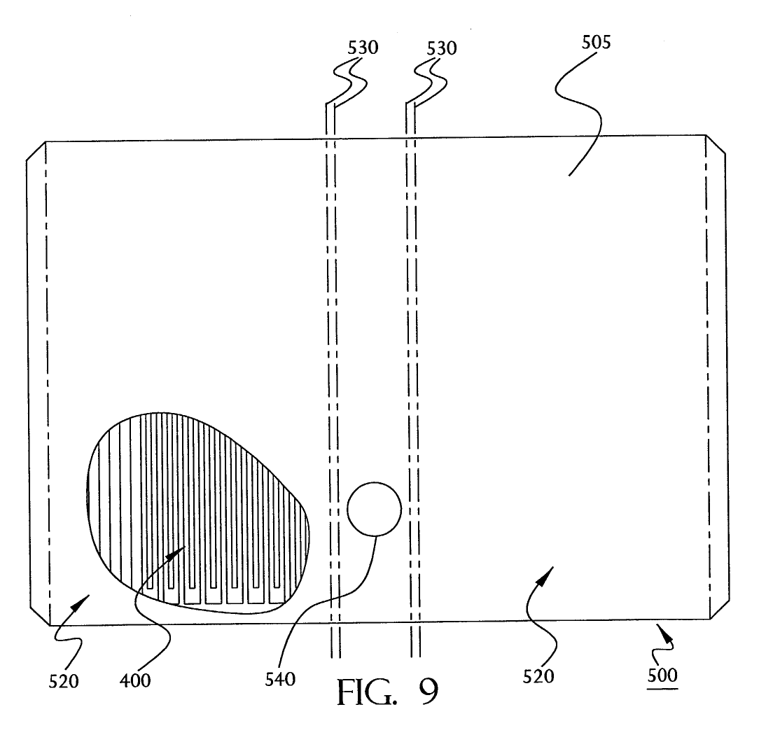

FIGS. 8 and 9 illustrate an exemplary heating element assembly which may be formed into a heating assembly 100 final element assembly. FIG. 8 is a top plan view of an exemplary resistance heating element 400. The resistance heating element 400 includes a supporting substrate 405 having a substantially rectangular profile corresponding to the flattened shape of a heating assembly. The profile may either be initially shaped in this profile shape or cut to the profile shape from a larger supporting substrate. Resistance heating material is affixed to the supporting substrate 405 and is preferably resistance wire 410 sewn to supporting substrate 405.

The resistance heating element 400 shown in FIG. 8 includes two flap portions 420 capable of rotation about a first axis of rotation indicated generally at fold lines 425. The circuit paths formed by resistance wires 410 continue onto flap portions 420 and terminate at terminal end portions 412.

FIG. 9 is a top plan view of a heating element assembly 500. The resistance heating element 400 is laminated between two thermoplastic sheets, only the top sheet 505 of which is shown, to form a reformable continuous element structure. A portion of the thermoplastic sheet 505 is shown removed in order to show the resistance heating element 400.

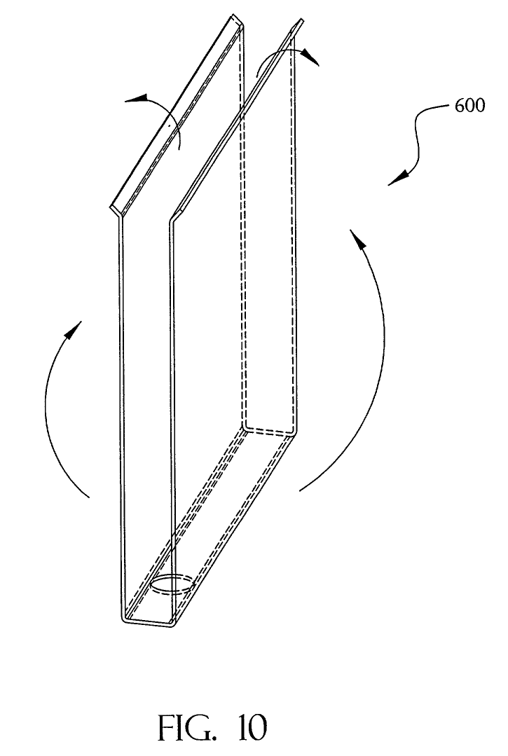

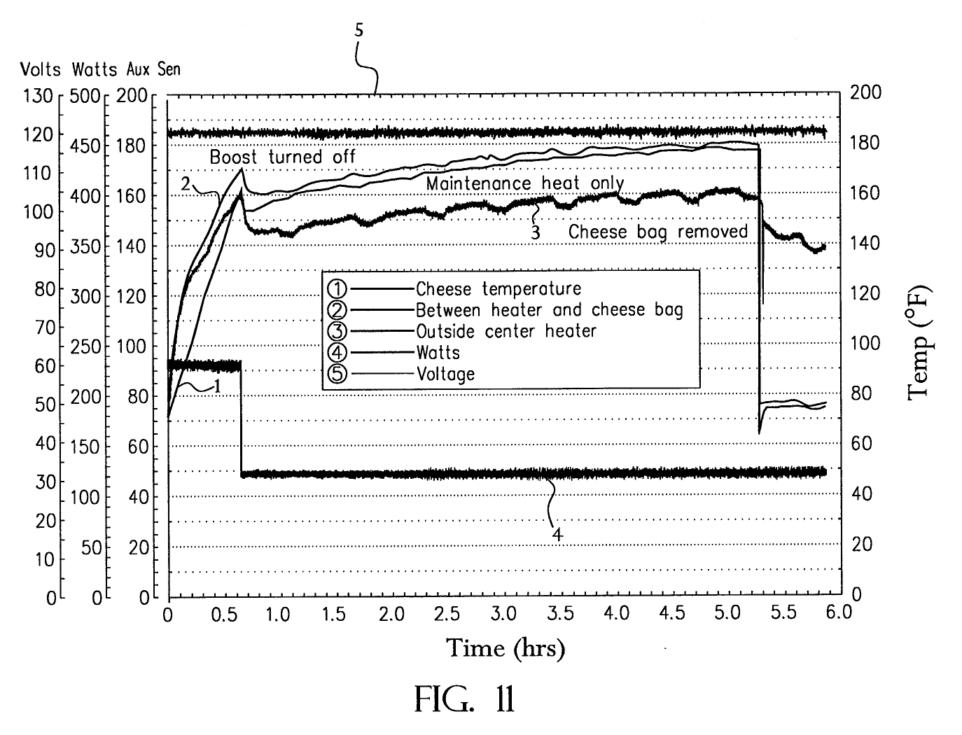

The dashed lines 530 indicate fold lines about which first and second flaps 520 may be folded to form the three-dimensional assembly 600 shown in FIG. 10.

A heating assembly 600 may be formed by folding the heating element assembly 500 along the dashed lines of FIG. 9 and in the direction of the arrows shown in FIG. 10. The flaps 420 of the resistance heating element 400 are laminated between thermoplastic layers and are folded into the tray shape shown in FIG. 10. The folding step may include rethermalizing the thermoplastic structure while folding in order to thermoform the structure into the desired heat planes, or, alternatively, folding the thermoplastic structure into the desired heat planes and then rethermalizing the structure, although it is recognized that the latter method introduces residual stresses in the bend areas.

It should be apparent that the heating assembly 600 can optionally provide heat on two different interior planes may, but is formed from an easily manufactured planar heating element assembly 500. It should further be apparent that the present invention is not limited in any way to the heating tray configuration 600 or heating element assembly 500 described above. Rather, the above describe method of manufacturing and heating element structure may be used to forms cups, enclosed containers, boxes, or any other structure which may be formed from a planar profile. The heating assembly and other configurations can include planar elements made from resistance heating wires, scrim, woven and nonwoven fabric and conductive filing such as conductive polymers, inks and foils. Such planar forms should have sufficient tensile strength to resist mechanical distortion of the circuit path, or heater distribution profile of the final product.

A sheet of heating element assemblies and a method of manufacturing the same is described hereafter. In another exemplary embodiment of the present invention, a sheet of heating element assemblies 225 is provided, as shown in FIG. 6. The sheet of heating element assemblies 225 includes first and second affixed thermoplastic sheets, as described above, and a sheet of resistance heating elements 200 (FIG. 7) secured between and to the first and second thermoplastic sheets. Essentially, the sheet of resistance heating elements 200 comprises a plurality of connected resistance heating elements 10. The sheet of resistance heating elements 200 comprises a supporting substrate 205 and a plurality of spaced pairs of circuit paths 207, each of the spaced pairs of circuit paths comprising at least one electrical resistance heating material attached to the supporting substrate 205 to define a pair of circuit paths, at least one of which includes a pair of terminal end portions 208, 209. The shape of the circuit paths 207 is merely illustrative of circuit path shapes, and any circuit path shape may be chosen to support the particular end use for a heating element assembly included in the sheet of heated element assemblies 225. Alternatively, conductive polymers or fabrics made from resistance heating material could be employed. The dashed lines of FIG. 7 indicate where an individual resistance heating element may be removed from the sheets of resistance heating elements 225.

A sheet 225 of heating element assemblies may be manufactured using conventional mass production and continuous flow techniques, such as are described in U.S. Pat. No. 5,184,969 to Sharpless et al., the entirety of which is incorporated herein by reference. For example, as illustrated in FIG. 6, first and second thermoplastic sheets 210, 212 may be provided from a source, such as rolls 214, 216 of thermoplastic sheets, or extruded using known extrusion techniques as a part of the manufacturing process. One manufacturer of such thermoplastic sheet extruders is Killion Extruders Inc. of Cedar Grove, N.J. Likewise, a sheet of resistance heating elements 200 may be provided from a source, such as roll 218. Sheet 200 may be manufactured as described above in the “Sewing Operation” section. The sheets 200, 212, 214 may be made to converge, such as by rollers 224, between a heat source, such as radiant heating panels 220, to soften the thermoplastic sheets 210, 212. A series of rollers 222 compresses the three sheets 200, 212, 214 into a sheet of heated element assemblies 225, thereby also removing air from between the sheets 200, 212, 214. The rollers 222 may also provide heat to help fuse the sheets 200, 212, 214 and/or may be used to cool freshly laminated sheets 200, 212, 214 to help solidify the heated sheets into the sheet of heated element assemblies 225 after compression.

It should be apparent that a sheet of a plurality of multiple-layered heating element assemblies, such as a sheet including a plurality of heating element assemblies 100a of FIG. 5, may also be manufactured simply by including a third thermoplastic sheet and a second sheet of resistance heating elements to the process described above.

Regardless of the specific manufacturing technique, the sheet of heating element assemblies 225 may be collected into a roll 230. The roll 230 may then be used by an original equipment manufacture (OEM) for any desired manufacturing purpose. For example, the OEM may separate or cut individual heating element assemblies from the roll and include the heating element assembly in a desired product by molding, adhesive or ultrasonic bonding, for example, into, e.g, a container or molded product. An individually manufactured heating element assembly as mentioned above or a heating element assembly removed from a sheet of heating element assemblies 225, because of its resiliency and good mechanical properties, is amenable to secondary manufacturing techniques, such as die cutting, stamping, or thermoforming to a desired shape or combination thereof as described above. Each heating element assembly may be cut or stamped into a preselected shape for use in a particular end product even while still a part of sheet 225 and then collected into a roll 230. The circuit paths of the resistance heating element of the heating element assembly may be appropriately shaped to conform to the desired shape of a selected product and heat planes in which the heating element assembly is to be included or formed.

The formable semi-rigid feature of the heating element assemblies of the present invention provides a designer the opportunity to include the assembly in complex heat planes. The assembly may be cut to a desired formable shape, and the circuit path is preferably designed to substantially conform to this shape or the desired heat planes. The assembly may then be rethermalized and folded to conform to the heat planes designed for the assembly to occupy.

A preferred thermoplastic sheet may range from approximately 0.004 inch to 0.100 inch. Thus, the thickness of the thermoplastic sheets of a heating element assembly may be chosen to effectively bias heat generated by a resistance heating element in a selected direction. The supporting substrate itself also may provide an insulation barrier when the circuit path is oriented towards, for example, contents to be heated and the supporting substrate is oriented toward an outer or gripping surface.

Similarly, one or both of the thermoplastic sheets of a heating element assembly 100 or heating element assembly 500 may be coated with a thermally conductive coating that promotes a uniform heat plane on the heated element assembly. An example of such a coating may be found on anti-static bags or Electrostatic Interference (ESI) resistive bags used to package and protect semiconductor chips. Also, thermally conductive, but preferably not electrically conductive, additive may be added to the thermoplastic sheets to promote heat distribution. Examples of such additive may be ceramic powders, such as, for example, Al₂O₃, MgO, ZrO₂, boron nitride, silicon nitride, Y₂O₃, SiC, SiO₂, TiO₂, etcetera. A thermally conductive layer and/or additive is useful because a resistance wire typically does not cover all of the surface area of a resistance heating element 10.

Advantageously, a heating assembly, formed in accordance with the invention, may be provided having varying surface watt densities in order to provide accurate heat placement.

### Experimental Results

A heating assembly was formed comprising two resistance heating circuit paths sandwiched between laminated layers of thermoplastic. The thermoplastic material used for both the inside and outside surfaces of the heating assembly was ULTEM 1000. The inside surface of the heating assembly was formed with two sheets of ULTEM 1000 having a total thickness of 0.02 inch. The outside surface of the heating assembly was formed from laminated sheets having a total thickness of 0.095 inch. Two resistance heating circuit paths were formed using resistance heating wires. The resistance heating circuit path used for temperature boosting was formed using resistance heating wire having a total impedance of 134.17 Ohms. The resistance heating circuit path used for maintenance heating was formed using resistance heating wire having a total impedance of 112.34 Ohms. The resistance heating wires were sewn to a fiberglass scrim substrate having an uncompressed thickness of about 0.030 inch. Each resistance heating wire may comprise a plurality of twisted, braided or parallel individual wires having a collective diameter of between about 0.010 inch to 0.050 inch. It will be understood that materials used in forming the heating assembly are not limited to the precise dimensions defined herein, which are merely provided by way of example.

The substrate, having a pair of resistance heating wires sewn thereto, was placed between top and bottom thermoplastic sheets to form a heating element assembly. Next, the heating element assembly was sandwiched in a manufacturing assembly. To this end, a Teflon sheet was placed adjacent to the exposed surface of each thermoplastic sheet, a layer of silicon rubber was placed adjacent each Teflon sheet, and a stainless steel plate was placed adjacent each silicon rubber sheet. The Teflon prevents the thermoplastic sheets from adhering to the manufacturing assembly, while the silicon rubber sheets provide a cushion which allows for even distribution of the hydraulic pressure applied bt the heat press. The stainless steel sheets act as stiffening agents to facilitate handling of the otherwise pliable assembly.

The resulting manufacturing assembly was then placed in a conventional heated press, with temperature platens preheated to 450 degrees Fahrenheit. The assembly was heated for 15 minutes at a pressure of 12,000 lbs. The assembly was then air cooled for 20 minutes, followed by a 2 minute water cooling period. The heater was then trimmed to final dimensions using a belt sander.

After forming and cooling the heating element assembly, the assembly was reheated along bend lines, about which the two flap portions were folded to reform the assembly into a final heating assembly configuration.

A performance graph for the above-described heating assembly is shown in FIG. 11. A standard sized bag of liquid cheese was heated in the heating assembly. The plot shows the cheese reached a temperature of 160 degrees Fahrenheit in 38 minutes with both the maintenance and boost heat on. At that point the boost heat was turned off. The cheese stabilized at 177 degrees Fahrenheit in 5.5 hours.

### Advantages of the Invention

A heating assembly in accordance with the invention provides more efficient heating of food products. Indeed, experimental results have shown that the present invention consumes ⅓ less wattage than traditional heating methods. This significant power savings is attributed in part to the intimate contact achievable between the heating assembly and the food product as compared to conventional heating methods. Another factor attributing to improved heating efficiency is the ability to design and manufacture the product with a varied watt density, thereby allowing the accurate placement of heat such that the food product can evenly warmed throughout, while preventing over warming of the food product.

Also, the heating assembly is hermetically sealed, making the assembly suitable for direct contact with food products, and allowing for the utilization of conventional cleaning techniques such as dishwashers etcetera, without compromising the integrity of the assembly.

The heating assembly is versatile in that it can be configured to adapt to existing vending machines. Yet another advantage of the invention is the thin yet rigid assembly geometry for more efficient utilization of space.

Further, as described above, the heating assembly of the present invention lends itself to many automated and secondary manufacturing techniques, such as stamping, die cutting, and overmolding, to name a few. Designers can easily choose thermoplastics and other materials for their designs that meet required RTI (relative thermal index) requirements for specific applications by following standard design techniques and parameters set by materials manufacturers Also, assemblies such as described above allow the food industry to efficiently and effectively reheat prepared foods, as is often required of businesses that operate large or small food service venues or that purchase from distributors of prepared foods. Also, among the many advantages of the present invention is the ability to intimately locate a secondary device captured between the thermoplastic sheets, such as a memory device or other data collector within close proximity to a food product, thereby allowing more accurate data collection, such as disclosed in commonly owned U.S. Pat. No. 6,417,335, herein incorporated in its entirety by reference. This data, as an example, may be used to prove that a food was prepared at a temperature and for a time period sufficient to kill the E. coli bacteria.

Although various embodiments have been illustrated, this is for the purpose of describing, but not limiting the invention. The assembly line described above is merely illustrative of one means of forming a sheet of heated element assemblies. Further, the supporting substrate shapes and circuit paths described above and shown in the drawings are merely illustrative of possible circuit paths, and one of ordinary skill should appreciate that these shapes and circuit patterns may be designed in other manners to accommodate the great flexibility in uses and number of uses for the heating element assembly of the present invention. Therefore, various modifications which will become apparent to one skilled in the art, are within the scope of this invention described in the attached claims.

We claim:

1. A method of manufacturing a heating assembly, comprising the steps of:
(a) disposing at least one resistance heating element between first and second thermoplastic sheets, each of the at least one resistance heating elements being attached to a supporting substrate and forming a circuit path
(b) laminating the first and second thermoplastic sheets such that each of the at least one resistance heating elements is secured between the first and second thermoplastic sheets to form a reformable structure; and
(c) forming the reformable structure into a heating assembly having a pair of side walls joined to a bottom wall having a smaller surface area then each said sidewalls, each of said sidewalls having disposed therein a portion one of the at least one resistance heating elements.

2. The method of claim 1 wherein each heating element substrate comprises a flap portion capable of rotation about a first axis of rotation, to form one of said side walls, at least one of the circuit paths continuing onto the flap portion, where the step of forming includes rotating the flap portion about the first axis to provide resistance heating in at least two planes.

3. The method of claim 1, wherein said step of laminating includes the steps of heating said thermoplastic sheets and compressing said thermoplastic sheets to laminate the resistance heating elements between the thermoplastic sheets.

4. The method of claim 1, wherein said step of forming comprises thermoforming the reformable structure into the heating assembly.

5. The method of claim 1, wherein said steps of providing the first and second thermoplastic sheets include the step of providing a thermoplastic bag including the first and second thermoplastic sheets and the step of laminating the first and second thermoplastic sheets includes the steps of evacuating air from the bag to compress the bag around the resistance heating elements and applying heat and pressure to the bag to fuse the first and second thermoplastic sheets and secure the resistance heating elements within said bag.

6. The method of claim 1, further comprising the step of cutting the reformable structure into a foldable profile before forming the reformable structure into the heating assembly.

7. The method of claim 1, wherein said step of providing the first and second thermoplastic sheets includes the step of providing a tubular-shaped thermoplastic body including the thermoplastic sheets and the step of disposing the resistance heating elements includes the step of disposing the resistance heating element within the tubular-shaped thermoplastic body.

8. The method of claim 1, further comprising the steps of:
(d) energizing at least one of the resistance heating elements to soften the thermoplastic sheets; and
(e) overmolding the heating assembly with a thermoplastic, the steps of energizing and overmolding timed such that the thermoplastic sheets and over molded thermoplastic form a substantially homogenous structure.

9. A method of manufacturing a heating assembly, comprising the steps of:
(a) disposing at least one resistance heating element between first and second thermoplastic sheets, each resistance heating element being attached to a supporting substrate and forming a circuit path,
(i) at least one of the circuit paths having terminal end portions,
(ii) at least one of the circuit paths continuing onto a first flap portion of the supporting substrate capable of rotation about a first axis of rotation;
(b) laminating the first and second thermoplastic sheets such that the at least one resistance heating element is secured between the first and second thermoplastic sheets to form a reformable heating element assembly, and
(c) thermoforming said reformable heating element assembly into a final heating assembly configuration having a pair of side walls joint to a bottom wall having a smaller surface area than each of said side walls, each of said side walls having disposed therein at least one of the circuit paths for generating electrical resistance heating for more uniformly heating a food product disposed within said heating assembly.

10. The method of claim 9, wherein said step of laminating includes the steps of heating the thermoplastic sheets and compressing the thermoplastic sheets to laminate said resistance heating elements between the thermoplastic sheets.

11. A method of manufacturing a sheet of heating element assemblies, comprising the steps of:
(a) disposing at least one sheet of resistance heating elements between first and second thermoplastic sheets, the resistance heating elements being attached to a supporting substrate, and forming a plurality of circuit paths in spaced apart pairs at least one of each pair of circuit paths continuing onto a first flap portion of a corresponding heating element, capable of rotation about a first axis of rotation; and
(b) laminating the first and second thermoplastic sheets such that the at least one sheet of resistance heating elements is secured between the first and second thermoplastic sheets to form a sheet of heating element assemblies, wherein each of the heating element assemblies is reformable into a heating assembly having a pair of side walls joined to a bottom wall having a smaller surface area than each of the side walls at least one of the side walls having disposed therein a portion of at least one of the corresponding pair of circuit paths.

13. The method of claim 12, further comprising the steps of removing at least one heating element assembly from the sheet of heating element assemblies, the removed heating element assembly being a reformable structure, and forming the reformable structure into a final element assembly configuration wherein at least the first flap portion of the resistance heating element is rotated about the first axis to provide resistance heating in at least two planes.

14. The method of claim 13, further comprising the step of cutting at least one of the heating element assemblies into a foldable profile before forming the reformable structure into the final element assembly configuration.

15. The method of claim 12, further comprising the steps of removing at least one heating element assembly from the sheet of heating element assemblies, the heating element assembly being a reformable structure, and forming the reformable structure into a final element assembly configuration wherein at least the first flap portion of the resistance heating element is rotated about said first axis to provide resistance heating in at least two planes.

16. The method of claim 14, wherein said step of cutting includes the step of one of stamping and die cutting at least one of the heating element assemblies into the profile.

17. The method of claim 12, wherein said step of disposing a said sheet of resistance heating elements between first and second thermoplastic sheets includes extruding a tubular-shaped thermoplastic body including said first and second thermoplastic sheets and disposing said sheet of resistance heating elements within said tubular-shaped thermoplastic body.

18. A heating element assembly, comprising:
(a) a first thermoplastic sheet;
(b) a second thermoplastic; and
(c) a plurality of resistance heating elements disposed between the first and second thermoplastic sheets and forming a plurality of circuit paths, the thermoplastic sheets and resistance heating elements being attached together to form a reformable structure, at least one of the circuit paths having terminal end portions, at least one of the circuit paths continuing onto a flap portion of the reformable structure capable of rotation about a first axis of rotation, the reformable structure formed into a final element assembly configuration having a pair of side walls joined to a bottom wall having a smaller surface area than each of the sidewalls, each of said side walls having disposed through a portion of at least one of the resistance heating elements.

19. The heating element assembly of claim 18, wherein the thermoplastic sheets are attached with an adhesive.

20. The heating element assembly of claim 18, wherein the thermoplastic sheets are attached with by one of fusing and laminating.

21. The heating element assembly of claim 18, wherein the reformable structure is thermoformed into said final element assembly configuration.

22. The heating element assembly of claim 18, wherein the reformable continuous structure is cut into a foldable profile.

23. The heating element assembly of claim 18, wherein the electrical resistance heating material is at least one of glued, sewn and fused to the supporting substrate.

24. The heating element assembly of claim 18, wherein the electrical resistance heating material is sewn to said supporting substrate with a thread.

25. The heating element assembly of claim 18, wherein the supporting substrate comprises at least one of a woven and non-woven fibrous layer.

26. The heating element assembly of claim 18, wherein the supporting substrate is a thermoplastic sheet.

27. The heating element assembly of claim 18, wherein the supporting substrate includes thermally conductive additives.

28. The heating element assembly of claim 18, wherein at least one of the thermoplastic sheets includes a thermally conductive coating.

29. The heating element assembly of claim 18, further comprising a secondary device secured between the first and second thermoplastic sheets.

30. The heating element assembly of claim 18, wherein one of the thermoplastic sheets is thicker than the other thermoplastic sheet.

31. The heating element assembly of claim 18, wherein the heating element assembly is over molded with a thermoplastic such that the over molded thermoplastic and thermoplastic sheets form a substantially homogenous structure.

32. The heating element assembly of claim 18, wherein at least one the circuit paths is a continuous loop, which is capable of being energized by at least one of high frequency radiation and magnetic induction.

33. The heating element assembly of claim 29, wherein the secondary device is one of, a thermistor, a sensor, a RTD and a thermocouple.

34. The heating element assembly of claim 18, wherein at least one of the thermoplastic sheets is Polyetherimide.

35. The heating element assembly of claim 18 wherein the final element assembly is hermetically sealed.

36. The heating element assembly of claim 18, wherein the circuit path density in the bottom wall of the element assembly is less than the circuit path density in the side walls.

37. The heating element assembly of claim 18, wherein the flap portions are outwardly flared to provide for nested engagement with a second identical heating assembly.

38. The heating element assembly of claim 18, wherein the bottom wall defines a through-hole for receiving a dispensing nozzle.

39. A method of manufacturing a sheet of heating element assemblies, comprising the steps of:
(a) disposing at least one sheet of resistance heating elements between first and second thermoplastic sheets, the resistance heating elements being attached to a supporting substrate, and forming a plurality of spaced pairs of circuit paths, at least one of each of the pairs of the spaced circuit paths having terminal end portions, at least one of each of the pairs of the spaced circuit paths continuing onto a first flap portion capable of rotation about a first axis of rotation; and
(b) laminating the first and second thermoplastic sheets such that the at least one sheet of resistance heating elements is secured between the first and second thermoplastic sheets to form a reformable structure, wherein each of the heating element assemblies is reformable into a heating assembly having a pair of side walls joined to a bottom wall having a smaller surface area than each of the side walls at least one of the side walls having disposed therein a portion of each of the plurality of circuit paths.

40. The method of claim 39, further comprising an adhesive affixing said first and second thermoplastic sheets.

41. The method of claim 39 wherein the electrical resistance heating material is at least one of glued, sewn and fused to the supporting substrate.

42. The method of claim 39 wherein said electrical resistance heating material is sewn to said supporting substrate with a thread.

43. The method of claim 39 wherein the supporting substrate comprises at least one of a woven and non-woven fibrous layer.

44. The method of claim 39 wherein the supporting substrate is an extruded thermoplastic sheet.

45. The method of claim 39 further comprising a plurality of secondary devices, each of said secondary devices disposed between said first and second thermoplastic sheets and associated with one of said circuit paths.

46. The method of claim 38 wherein at least one of the thermoplastic sheets includes a thermally conductive coating.

47. A heating assembly, comprising:
(a) a single integral construction comprising first and second generally parallel polymeric side walls connected to a narrow polymeric bottom portion;
(b) a resistance heating element disposed within the first and second side walls, the resistance heating element comprising:
(i) a supporting substrate;
(ii) at least two circuit paths, a first and second of said circuit paths comprising an electrical resistance heating material attached to, or disposed within, the supporting substrate, and disposed within said first and second side walls respectively;
(c) a pair of terminal end portions electrically connected to at least one of said circuit paths.

48. The heating assembly of claims 47, wherein said bottom portion contains a nozzle opening.

49. The heating assembly of claim 47, wherein said two circuit paths are electrically joined in a series or in parallel.

50. The heating assembly of claim 47, wherein the two circuit paths have different watt densities.
